(19) United States
(12) Patent Application Publication
(10) Pub. No.: US 2013/0057426 A1
(43) Pub. Date: Mar. 7, 2013

(54) PULSED LEVEL GAUGE SYSTEM WITH SUPPLY VOLTAGE CONTROLLED DELAY

(71) Applicants: Fabian Wenger, Goteborg (SE); Samuel Bergqvist, Goteborg (SE); Valter Nilsson, Hovas (SE)

(72) Inventors: Fabian Wenger, Goteborg (SE); Samuel Bergqvist, Goteborg (SE); Valter Nilsson, Hovas (SE)

(21) Appl. No.: 13/225,867

(22) Filed: Sep. 6, 2011

(51) Int. Cl. G01S 13/08

(52) U.S. Cl. 342/124

(57) ABSTRACT

A level gauge system comprising transmission signal generating circuitry for generating a transmission signal; a propagation device connected to the transmission signal generating circuitry and arranged to propagate the transmission signal towards a surface of the product inside the tank, and to return a reflected signal resulting from reflection of the transmission signal at the surface of the product contained in the tank. The level gauge system further comprises reference signal providing circuitry configured to provide a reference signal. At least one of the transmission signal generating circuitry and the reference signal providing circuitry comprises delay circuitry. The delay circuitry comprises at least one delay cell exhibiting a propagation delay for pulses passing through the at least one delay cell that varies in dependence of a supply voltage provided to the at least one delay cell, and voltage control circuitry connected to the at least one delay cell.

### TECHNICAL FIELD OF THE INVENTION

The present invention relates to a method of determining a filling level of a product contained in a tank using a pulsed radar level gauge system, and to a pulsed radar level gauge system.

### Technical Background

Radar level gauge (RLG) systems are in wide use for determining the filling level of a product contained in a tank. Radar level gauging is generally performed either by means of non-contact measurement, whereby electromagnetic signals are radiated towards the product contained in the tank, or by means of contact measurement, often referred to as guided wave radar (GWR), whereby electromagnetic signals are guided towards and into the product by a probe acting as a waveguide. The probe is generally arranged to extend vertically from the top towards the bottom of the tank. The probe may also be arranged in a measurement tube, a so-called chamber, that is connected to the outer wall of the tank and is in fluid connection with the inside of the tank.

The transmitted electromagnetic signals are reflected at the surface of the product, and the reflected signals are received by a receiver or transceiver comprised in the radar level gauge system. Based on the transmitted and reflected signals, the distance to the surface of the product can be determined.

More particularly, the distance to the surface of the product is generally determined based on the time between transmission of an electromagnetic signal and reception of the reflection thereof in the interface between the atmosphere in the tank and the product contained therein. In order to determine the actual filling level of the product, the distance from a reference position to the surface is determined based on the above-mentioned time (the so-called time-of-flight) and the propagation velocity of the electromagnetic signals.

Most radar level gauge systems on the market today are either so-called pulsed radar level gauge systems that determine the distance to the surface of the product contained in the tank based on the difference in time between transmission of a pulse and reception of its reflection at the surface of the product, or systems that determine the distance to the surface based on the phase difference between a transmitted frequency-modulated signal and its reflection at the surface. The latter type of systems are generally referred to as being of the FMCW (Frequency Modulated Continuous Wave) type.

For pulsed radar level gauge systems, time expansion techniques are generally used to resolve the time-of-flight.

Such pulsed radar level gauge systems typically have a first oscillator for generating a transmission signal formed by pulses for transmission towards the surface of the product contained in the tank with a transmitted pulse repetition frequency fₜ, and a second oscillator for generating a reference signal formed by reference pulses with a reference pulse repetition frequency fᵣ that differs from the transmitted pulse repetition frequency by a given frequency difference Δf. This frequency difference Δf is typically in the range of Hz or tens of Hz.

At the beginning of a measurement sweep, the transmission signal and the reference signal are synchronized to have the same phase. Due to the frequency difference Δf, the phase difference between the transmission signal and the reference signal will gradually increase during the measurement sweep.

During the measurement sweep, the reflection signal formed by the reflection of the transmission signal at the surface of the product contained in the tank is being correlated with the reference signal, so that an output signal is only produced when a reflected pulse and a reference pulse occur at the same time. The time from the start of the measurement sweep to the occurrence of the output signal resulting from the correlation of the reflection signal and the reference signal is a measure of the phase difference between the transmission signal and the reflection signal, which is in turn a time expanded measure of the time-of-flight of the reflected pulses, from which the distance to the surface of the product contained in the tank can be determined.

Since the accuracy of the frequency difference Δf between the transmission signal and the reference signal is important to the performance of the pulsed radar level gauge system, the second oscillator can be controlled by a regulator that monitors the frequency difference Δf and regulates the second oscillator to maintain the predetermined frequency difference Δf.

To provide a stable regulation, the regulator may typically need in the order of hundreds of samples of the frequency difference Δf, which corresponds to a time duration which can be as long as 20-30 seconds due to the low value of the frequency difference Δf that is desired to achieve a sufficient time expansion.

Accordingly, the above-described type of currently available pulsed radar level gauge systems typically need to be powered for a substantial period of time before the actual filling level measurement can start.

### SUMMARY OF THE INVENTION

In view of the above-mentioned and other drawbacks of the prior art, a general object of the present invention is to provide an improved pulsed level gauge system and method, and in particular a pulsed level gauge system and method enabling a more energy efficient filling level determination.

According to a first aspect of the present invention, these and other objects are achieved through a level gauge system, for determination of a filling level of a product contained in a tank using electromagnetic signals, the level gauge system comprising: transmission signal generating circuitry for generating a transmission signal in the form of a sequence of transmission pulses; a propagation device connected to the transmission signal generating circuitry and arranged to propagate the transmission signal towards a surface of the product inside the tank, and to return a reflected signal resulting from reflection of the transmission signal at the surface of the product contained in the tank; reference signal providing circuitry configured to provide a reference signal in the form of a sequence of reference pulses, at least one of the transmission signal generating circuitry and the reference signal providing circuitry comprising delay circuitry for providing a time-varying phase difference between the transmission signal and the reference signal; measurement circuitry connected to the propagation device and to the reference signal providing circuitry, the measurement circuitry being configured to provide a measurement signal based on the reference signal and the reflected signal; and processing circuitry connected to the measurement circuitry for determining a filling level based on the measurement signal, wherein the delay circuitry comprises: at least one supply voltage controlled delay cell exhibiting a propagation delay for pulses passing through the at least one supply voltage controlled delay cell that varies in dependence of a supply voltage provided to the at least one supply voltage controlled delay cell; and voltage control circuitry connected to the at least one supply voltage controlled delay cell for providing a controllable supply voltage to the at least one supply voltage controlled delay cell, to thereby allow control of a signal propagation delay of the delay circuitry.

The tank may be any container or vessel capable of containing a product, and may be metallic, or partly or completely non-metallic, open, semi-open, or closed. Furthermore, the filling level of the product contained in the tank may be determined directly by using a signal propagation device propagating the transmission signal towards the product inside the tank, or indirectly by using a propagation device disposed inside a so-called chamber located on the outside of the tank, but being in fluid connection with the inside of the tank in such a way that the level in the chamber corresponds to the level inside the tank. The transmission signal is an electromagnetic signal.

The “propagation device” may be any device capable of propagating electromagnetic signals, including transmission line probes, waveguides and various types of antennas, such as horn antennas, array antennas etc. It should be noted that any one or several of the means comprised in the processing circuitry may be provided as either of a separate physical component, separate hardware blocks within a single component, or software executed by one or several microprocessors.

The present invention is based on the realization that a controllable timing difference between the transmission pulses and the reference pulses can be achieved with a very high precision using at least one supply voltage controlled delay cell that exhibits a supply voltage dependent propagation delay, and controlling the supply voltage.

One or several supply voltage controlled delay cell(s) and voltage control circuitry for controlling the supply voltage to the supply voltage controlled delay cell(s) may be comprised in either the transmission signal generating circuitry or the reference signal providing circuitry or both. For example, the transmission signal generating circuitry may comprise oscillator circuitry, such as a voltage controlled oscillator, and the reference signal providing circuitry may comprise delay circuitry for providing a reference signal in the form of a delayed version of the transmission signals.

Through the use of delay circuitry comprising at least one supply voltage controlled delay cell exhibiting a supply voltage dependent propagation delay and voltage control circuitry for controlling the supply voltage, the delay can be controlled to a desired value at any time. This allows for various power saving operation modes of the level gauge system.

For example, a ‘quick search’ mode can be used where the delay is varied rapidly by quickly varying the supply voltage. Hereby, the surface of the product in the tank can quickly be found, and subsequent measurements may be carried out for a limited range around the distance to the surface. To measure across a limited range like this saves time and power as compared to performing “complete” measurements across the entire range of the level gauge system. The thus saved power as compared to a measurement across the entire range of the level gauge system may, for example, be used to instead oversample a selected range or “window” a number of times, whereby the sensitivity can be improved.

The transmission signal generating circuitry and the reference signal providing circuitry may advantageously provide the transmission signal and the reference signal, respectively, based on input from a common pulse generating circuit.

According to various embodiments of the present invention, however, the transmission signal generating circuitry and the reference signal providing circuitry may be connected to, or may comprise, different pulse generating circuitry, such as different oscillators.

Furthermore, the delay circuitry may comprise a plurality of supply voltage controlled delay cells connected in series, each supply voltage controlled delay cell exhibiting a propagation delay for pulses passing through the supply voltage controlled delay cell that varies in dependence of a supply voltage provided to the supply voltage controlled delay cell.

Hereby, the achievable delay range can be extended as compared to the case with a single supply voltage controlled delay cell.

The voltage control circuitry may be connected to each of the supply voltage controlled delay cells to allow simultaneous control of the supply voltage provided to each of the supply voltage controlled delay cells. In this configuration, the total delay becomes the sum of the individual delays for a given supply voltage of the supply voltage controlled delay cells.

According to various embodiments of the present invention, the delay circuitry may further comprise a plurality of delay elements, which may or may not be supply voltage controlled delay cells; and controllable switching circuitry arranged and configured to allow formation of a delay path through a selected number of the delay elements connected in series.

Through the use of delay circuitry comprising a plurality of delay elements, each providing a known propagation delay (which may be the same for all delay elements, or differ between delay elements) for electromagnetic signals passing therethrough, and controllable switching circuitry arranged and configured to allow formation of a delay path through a selected number of the delay elements connected in series, the delay can be controlled across an even wider range. Fine tuning of the delay can be provided by controlling the supply voltage of one or several supply voltage controlled delay cells comprised in the delay circuitry.

Alternatively, the delay elements forming the delay path may be comprised in the reference signal providing circuitry and the at least one supply voltage controlled delay cell may be comprised in the transmission signal generating circuitry, or vice versa.

In these embodiments, variation of the total propagation delay of the delay circuitry may be achieved by varying the number of delay elements forming the delay path and, for each number of delay elements, varying the supply voltage provided to the supply voltage controlled delay cell(s) that exhibit(s) a supply voltage dependent propagation delay.

For formation of the delay path, the switching circuitry may comprise controllable switching elements arranged between adjacent ones of the delay elements. Alternatively, all of the delay elements may be connected in series, and the switching circuitry may comprise controllable switching elements for connecting a selected one of the delay elements to an output of the delay circuitry.

To provide for characterization and/or adjustment of the delay circuitry, the level gauge system may further comprise a phase detector arranged to provide a signal indicative of a propagation delay through the delay circuitry. This signal may be used to achieve a stable and accurate control of the total propagation delay of the delay circuitry.

For example, the voltage control circuitry used for controlling the supply voltage provided to the supply voltage controlled delay cell(s) may be connected to the phase detector and configured to provide the controllable supply voltage in dependence of the signal provided by the phase detector.

In various embodiments of the present invention, the at least one supply voltage controlled delay cell may be a logic circuit comprising at least one transistor. One example of such a logic circuit is an inverter, but it should be noted that the delay cells/delay cells may be implemented as any one of a large number of different logic circuits, such as an AND-gate, a NAND-gate, an OR-gate, a NOR-gate, etc.

The propagation device may be a transmission line probe arranged to extend towards and into the product contained in the tank for guiding the transmission signal towards the surface of the product, and guiding the reflected signal back along the transmission line probe.

According to another embodiment, the propagation device may comprise an antenna device for radiating the transmission signal towards the surface of the product contained in the tank and capturing the reflected signal resulting from reflection of the transmission signal at the surface of the product contained in the tank.

Furthermore, the level gauge system may advantageously be configured to be powered by a local power source, which may, for example, comprise a battery, a wind turbine, and/or solar cells etc.

Moreover, the level gauge system may further comprise a radio transceiver for wireless communication with an external device.

According to a second aspect of the present invention, the above-mentioned and other objects are achieved through a method of determining a filling level of a product contained in a tank using electromagnetic signals, the method comprising the steps of: generating a transmission signal in the form of a sequence of pulses; propagating the transmission signal towards a surface of the product contained in the tank; receiving a reflected signal resulting from reflection of the transmission signal at the surface of the product; providing a reference signal in the form of a sequence of pulses; forming a measurement signal based on the reference signal and the reflected signal; and determining the filling level based on the measurement signal, wherein at least one of the steps of generating the transmission signal and providing the reference signal comprises the steps of: passing the pulses through at least one supply voltage controlled delay cell exhibiting a propagation delay for the pulses that varies in dependence of a supply voltage provided to the at least one supply voltage controlled delay cell; and varying the supply voltage to the at least one supply voltage controlled delay cell, to thereby provide a time-varying phase difference between the transmission signal and the reference signal.

Further embodiments of, and effects obtained through this second aspect of the present invention are largely analogous to those described above for the first aspect of the invention.

### BRIEF DESCRIPTION OF THE DRAWINGS

These and other aspects of the present invention will now be described in more detail, with reference to the appended drawings showing example embodiments of the invention, wherein:

FIG. 1 schematically illustrates a level gauge system according to an embodiment of the present invention installed in an exemplary tank;

FIG. 2 is a schematic illustration of the measurement electronics unit comprised in the level gauge system in FIG. 1;

FIG. 3 is a block diagram schematically illustrating the level gauge system in FIG. 1;

FIG. 4a schematically illustrates a first exemplary embodiment of the delay circuitry comprised in the level gauge system of FIG. 3;

FIG. 4b is a diagram illustrating the propagation delay achievable using the delay circuitry in FIG. 4a;

FIG. 4c schematically shows the dependence of the propagation delay on supply voltage for an exemplary supply voltage controlled delay cell comprised in the delay circuitry in FIG. 4a;

FIG. 5 schematically illustrates a second exemplary embodiment of the delay circuitry comprised in the level gauge system of FIG. 3;

FIG. 6 schematically illustrates a third exemplary embodiment of the delay circuitry comprised in the level gauge system of FIG. 3;

FIG. 7 schematically illustrates a fourth exemplary embodiment of the delay circuitry comprised in the level gauge system of FIG. 3; and

FIG. 8 is a flow chart schematically illustrating an embodiment of the method according to the present invention.

### DETAILED DESCRIPTION OF EXAMPLE EMBODIMENTS OF THE INVENTION

In the present detailed description, various embodiments of the level gauge system according to the present invention are mainly discussed with reference to a pulsed radar level gauge system of the non-contact type, in which an electromagnetic signal is propagated towards the product contained in the tank using a propagating device in the form of a radiating antenna, such as a cone antenna, a horn antenna, an array antenna or a patch antenna.

It should be noted that this by no means limits the scope of the present invention, which is equally applicable to pulsed guided wave radar (GWR) level gauge system utilizing a propagating device in the form of a probe, such as a single line probe (including a so-called Goubau probe), a two-lead probe, a coaxial probe, etc.

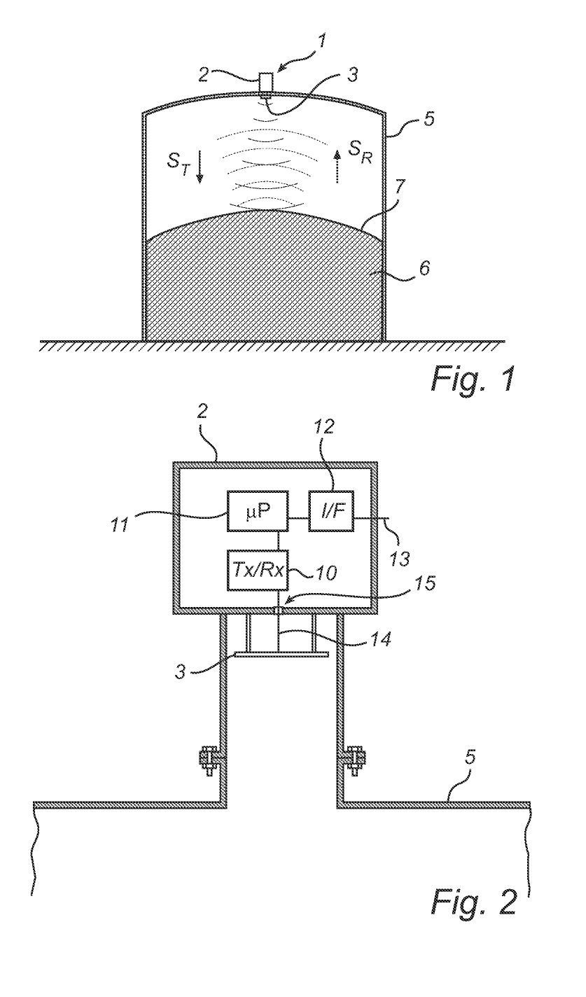

FIG. 1 schematically illustrates a level gauge system 1 according to an embodiment of the present invention, comprising a measurement electronics unit 2, and a propagation device in the form of a radiating antenna device 3. The radar level gauge system 1 is provided on a tank 5, which is partly filled with a product 6 to be gauged. In the case illustrated in FIG. 1, the product 6 is a solid, such as grain or plastic pellets, but the product may equally well be a liquid, such as water or a petroleum-based product. By analyzing a transmission signal S_{T} being radiated by the antenna device 3 towards the surface 7 of the product 6, and a reflected signal S_{R} traveling back from the surface 7, the measurement electronics unit 2 can determine the distance between a reference position and the surface 7 of the product 6, whereby the filling level can be deduced. It should be noted that, although a tank 5 containing a single product 6 is discussed herein, the distance to any material interface present in the tank 5 can be measured in a similar manner.

As is schematically illustrated in FIG. 2, the electronics unit 2 comprises a transceiver 10 for transmitting and receiving electromagnetic signals, a processing unit 11, which is connected to the transceiver 10 for control of the transceiver and processing of signals received by the transceiver to determine the filling level of the product 6 in the tank 5.

The processing unit 11 is, furthermore, connectable to external communication lines 13 for analog and/or digital communication via an interface 12. Moreover, although not shown in FIG. 2, the radar level gauge system 1 is typically connectable to an external power source, or may be powered through the external communication lines 13. Alternatively, the radar level gauge system 1 may be powered locally, and may be configured to communicate wirelessly.

Although being shown as separate blocks in FIG. 2, several of the transceiver 10, the processing circuitry 11 and the interface 12 may be provided on the same circuit board.

In FIG. 2, furthermore, the transceiver 10 is illustrated as being separated from the interior of the tank 5 and connected to the antenna device 3 via a conductor 14 passing through a feed-through 15 provided in the tank wall. It should be understood that this is not necessarily the case, and that at least the transceiver 10 may be provided in the interior of the tank 5. For example, in case the antenna device 3 is provided in the form of a patch antenna as is schematically illustrated in FIG. 2, at least the transceiver 10 and the patch antenna 3 may be provided on the same circuit board.

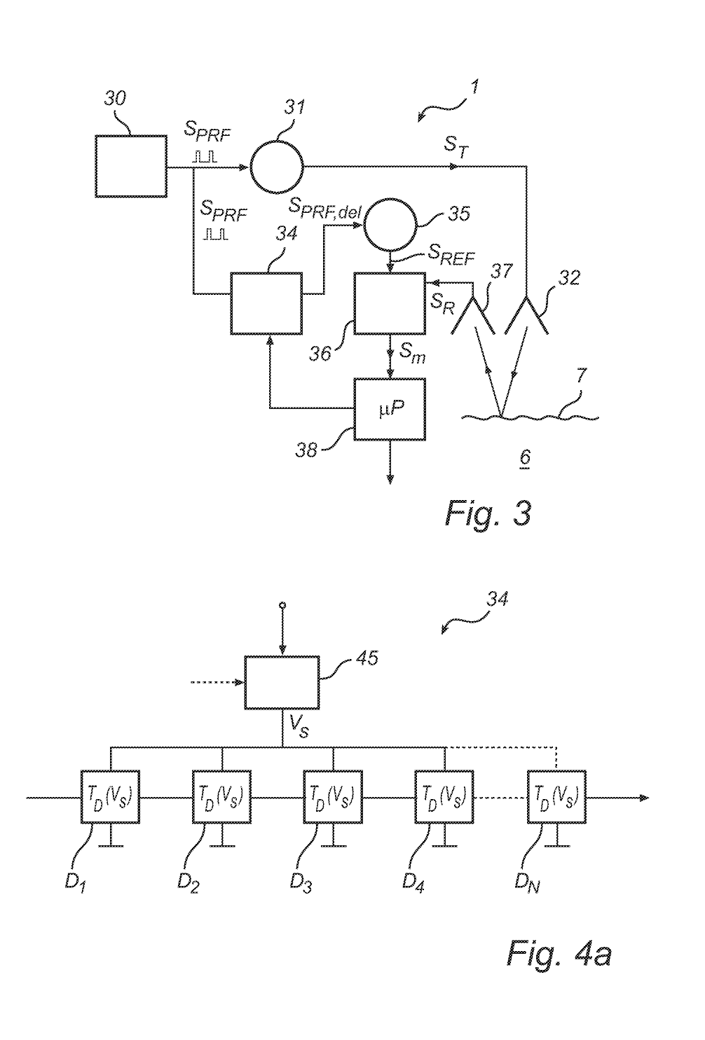

FIG. 3 is a block diagram schematically showing functional components comprised in the level gauge system in FIG. 1. The exemplary level gauge system 1 comprises a transmitter branch and a receiver branch.

The transmitter branch comprises transmission signal generating circuitry, here provided in the form of a pulse generator 30, an RF-source 31 and a transmitting antenna 32, and the receiver branch comprises reference signal providing circuitry in the form of delay circuitry 34, a local oscillator 35, measurement circuitry 36 and a receiving antenna 37.

The microwaves generated by the RF-source 31 are modulated by the pulses S_{PRF} provided by the pulse generator 30 so that a transmission signal S_{T} in the form of a sequence of transmission pulses (short “packets” of microwave energy) is formed and is radiated towards the surface 7 of the product by the transmitting antenna 32.

The reflected signal S_{R} is received by the receiving antenna 37 and is forwarded to the measurement circuitry 36. The measurement circuitry 36 is also provided with a reference signal S_{REF}, which is formed by delaying the pulses S_{PRF} provided by the pulse generator 30 using the delay circuitry 34 and feeding the delayed pulses S_{PRF,del} to the local oscillator 35. The delay circuitry 34 is controlled, which is schematically illustrated by the line from microprocessor 38 to delay circuitry 34, to vary the delay so that the timing difference between the transmission pulses and the reference pulses varies (increases or decreases) over time.

In the measurement circuitry 36, the reference signal S_{REF} and the reflected signal S_{R} are time correlated to form a time-expanded measurement signal Sₘ, which is provided to the microprocessor 38, where the distance to the surface 7 of the product 6 is determined based on the measurement signal Sₘ.

In the exemplary embodiment described above, the reference signal S_{REF} is a delayed version of the transmission signal S_{T}. As will be evident to those skilled in the art, the delay circuitry 34 could equally well be provided on the transmitter branch for delaying the transmission signal so that the transmission signal S_{T} becomes a delayed version of the reference signal S_{REF}. Alternatively, the delay circuitry could be configured to provide delay on both the transmitter branch and the receiver branch. For instance, coarse delay could be provided on the receiver branch and fine delay on the transmitter branch and vice versa.

The measurement circuitry 36 may, for example, comprise a mixer and a sample-and-hold amplifier, but could also be implemented in other ways known to those skilled in the art. For example, the sample-and-hold amplifier may be configured to achieve time-correlation by controlling the sampling switch using the reference signal S_{REF}.

Moreover, for so-called guided wave radar (GWR), the pulses S_{PRF} generated by pulse generator 30 could be propagated directly towards the surface using a transmission line probe. Such a GWR-system may thus function without the RF-source 31 and the local oscillator 35 indicated in FIG. 3.

In other embodiments of the invention, the transmitter branch and the receiver branch may have different pulse generators.

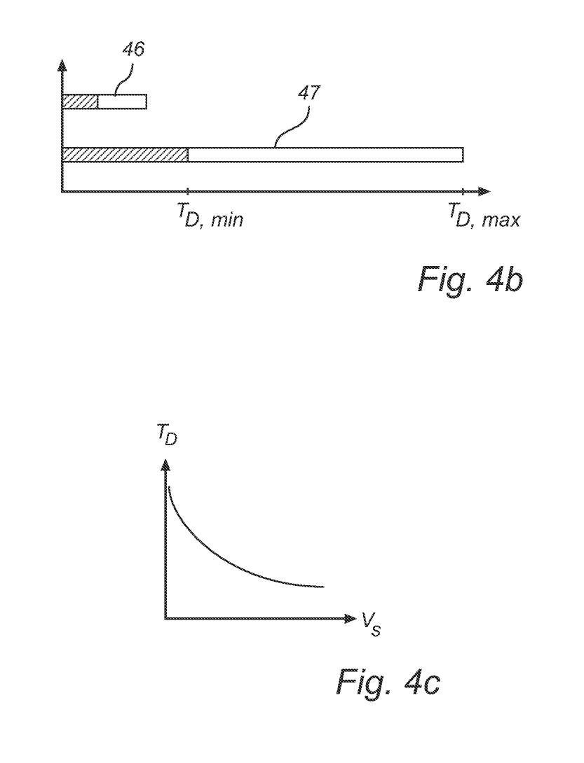

FIG. 4a schematically illustrates a first exemplary embodiment of the delay circuitry 34 in FIG. 3. Referring to FIG. 4a, the delay circuitry 34 comprises a plurality of supply voltage controlled delay cells D₁-D_{N} connected in series and voltage control circuitry 45 arranged to allow control of the supply voltage Vₛ provided to the supply voltage controlled delay cells D₁-D_{N}. Each of the supply voltage controlled delay cells D₁-D_{N} exhibits a propagation delay for pulses passing therethrough that varies in dependence of the supply voltage provided to the supply voltage controlled delay cell. The delay circuitry 34 may, for example, be implemented in an FPGA, and the supply voltage controlled delay cells D₁-D_{N} may be inverters.

By connecting a plurality of supply voltage controlled delay cells D₁-D_{N} in series, the delay range T_{D,min}-T_{D,max} can be increased as compared to when a single supply voltage controlled delay cell Dₙ is used.

This is schematically illustrated in FIG. 4b, where the top bar 46 illustrates the tunable delay range (dotted) for a single supply voltage controlled delay cell Dₙ, and the bottom bar 47 illustrates the tunable delay range (dotted) for the delay circuitry 34 in FIG. 4a, comprising a plurality of supply voltage controlled delay cells D₁-D_{N} connected in series.

As was mentioned above, each supply voltage controlled delay cell Dₙ exhibits a propagation delay T_{D} that varies in dependence of the supply voltage Vₛ. An example of a supply voltage controlled delay cell Dₙ is a logic circuit, which may be implemented using CMOS technology. Such logic circuits exhibit propagation delays that become shorter with increasing supply voltage Vₛ.

FIG. 4c schematically shows an exemplary dependence of the propagation delay T_{D} on the supply voltage for an example logic circuit in the form of an inverter.

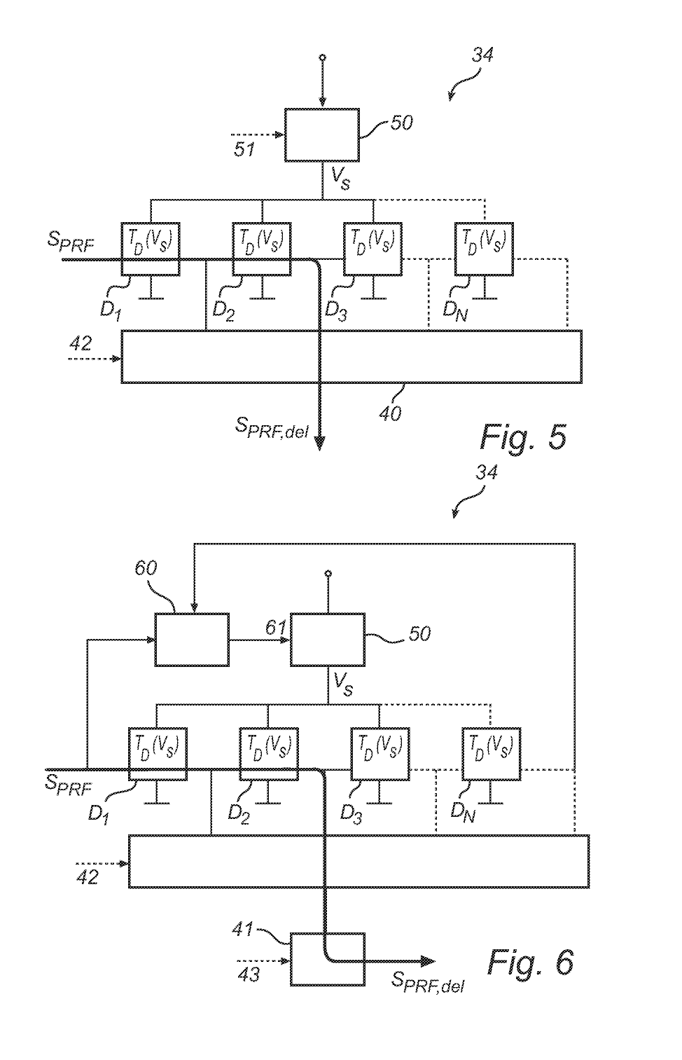

A second exemplary embodiment of the delay circuitry 34 in FIG. 3 will now be described with reference to FIG. 5. The delay circuitry 34 in FIG. 5 differs from that described above with reference to FIG. 4a in that it further comprises switching circuitry 40 that is controllable to form a delay path (indicated by the bold line in FIG. 5) through a selected number of the supply voltage controlled delay cells D₁-D_{N}.

The switching circuitry 40 is controllable to form a delay path, exemplified by the bold line in FIG. 4a, through a selected number of the supply voltage controlled delay cells D₁-D_{N}, in this case through D₁ and D₂.

The switching circuitry can be implemented in various ways which will be easily realized by those skilled in the art. Of course, the switching circuitry will introduce an additional delay, which, if required, may be compensated for by introducing a corresponding delay in the other branch (in this case in the transmitter branch).

As was described above with reference to FIG. 4a, each of the supply voltage controlled delay cells D₁-D_{N} exhibits a propagation delay T_{D}(Vₛ) that varies in dependence of the supply voltage Vₛ provided to the delay cells D₁-D_{N}. In analogy with the embodiment of the delay circuitry 34 described above with reference to FIG. 4a, the delay circuitry 34 in FIG. 5 further comprises voltage control circuitry 50 arranged and configured to provide the supply voltage controlled delay cells D₁-D_{N} with a supply voltage Vₛ determined by the control signal 51 provided to the voltage control circuitry 50.

With this configuration, the total propagation delay of the delay circuitry 34 can be precisely controlled by determining the number of supply voltage controlled delay cells to be included in the delay path (D₁ and D₂ in the exemplary case schematically illustrated in FIG. 5) using the switching circuitry 40 and controlling the delay time T_{D}(Vₛ) of these supply voltage controlled delay cells D₁ and D₂ by controlling the supply voltage Vₛ using the voltage control circuitry 50.

To provide for delay control/regulation and/or calibration of the delay circuitry, a feedback configuration may be used. An example of such a feedback configuration will be described below with reference to FIG. 6.

Similarly to the delay circuitry described above with reference to FIG. 5, the delay circuitry 34 in FIG. 6 comprises supply voltage controlled delay cells D₁-D_{N}, switching circuitry 40 and voltage control circuitry 50. In addition, the delay circuitry 34 in FIG. 6 comprises a phase detector arranged to provide a signal 61 indicative of the propagation delay through all of the supply voltage controlled delay cells D₁-D_{N}. This signal 61 can in turn be used to control the supply voltage Vₛ provided to the supply voltage controlled delay cells D₁-D_{N} to keep the propagation delay through all of the supply voltage controlled delay cells constant. In this manner, the propagation delay T_{D} of each of the supply voltage controlled delay cells D₁-D_{N} can be kept substantially constant.

After having passed through the selected supply voltage controlled delay cells, the signal is routed through the delay tuning unit 41 comprising at least one supply voltage controlled delay cell and voltage control circuitry connected to the at least one supply voltage controlled delay cell, where a further controllable delay t_{d} may be added to further increase the resolution of the total propagation delay. During a timing sweep, the switching circuit 40 may first be controlled, through a switching circuit control signal 42 to pass the signal S_{PRF} to be delayed directly to the delay tuning unit 41, which is controlled by the delay tuning control signal 43 to sweep from t_{d,min} to t_{d,max}. Thereafter, the switching circuit 40 is controlled to pass the signal S_{PRF} to be delayed through the first delay cell D₁, and the delay tuning unit 41 is again controlled to sweep from t_{d,min} to t_{d,max}, etc.

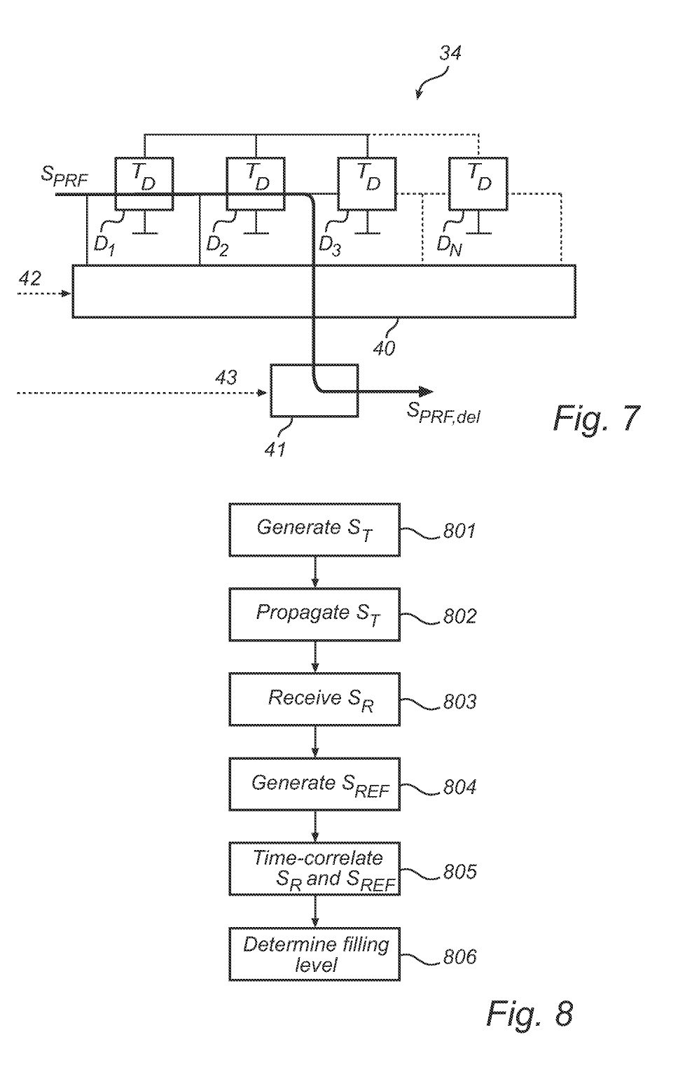

A further exemplary configuration of the delay circuitry 34 of the level gauge system 1 in FIG. 3 will now be described with reference to FIG. 7.

As is schematically illustrated in FIG. 7, the delay circuitry 34 comprises a plurality of delay cells D₁-D_{N}, switching circuitry 40 and a delay tuning unit 41. In this exemplary embodiment, the delay cells are not supply voltage controlled, that is, the supply voltage provided to the delay cells is substantially constant. Each delay cell D₁-D_{N} has a propagation delay T_{D}, as is schematically illustrated in FIG. 7. The switching circuitry 40 is controllable to form a delay path, exemplified by the bold line in FIG. 4a, through a selected number of the delay cells D₁-D_{N}, in this case through D₁ and D₂. Since, in this example, each delay cell D₁-D_{N} has a propagation delay T_{D}, the total propagation delay through D₁ and D₂ is 2 T_{D}.

The total propagation delay of the delay circuitry can be controlled in the same way as was described above with reference to FIG. 6.

An embodiment of the method according to the present invention will now be described with reference to the flow chart in FIG. 8.

Referring to FIG. 8, a transmission signal in the form of a sequence of transmission pulses is generated in a first step 801, in the next step 802, the transmission signal is propagated towards a surface of the product contained in the tank. The transmission signal is reflected at the surface and is returned as a reflected signal. This reflected signal is received in step 803.

In step 804, pulses from the pulse generating circuitry used to generate the transmission signal are passed through one or several supply voltage controlled delay cells which are provided with a time-varying supply voltage in order to form a reference signal in the form of a delayed copy of the transmission signal with a time-varying delay.

In the subsequent step 805, a measurement signal is formed by time correlating the reflected signal and the reference signal, and in step 806, the filling level is determined based on the measurement signal formed in step 805.

It is noted that the invention has mainly been described above with reference to a few embodiments. However, as is readily appreciated by a person skilled in the art, other embodiments than the ones disclosed above are equally possible within the scope of the invention, as defined by the appended claims.

It is further noted that, in the claims, the word “comprising” does not exclude other elements or steps, and the indefinite article “a” or “an” does not exclude a plurality. A single apparatus or other unit may fulfill the functions of several items recited in the claims. The mere fact that certain measures are recited in mutually different dependent claims does not indicate that a combination of these measured cannot be used to advantage.

1. A level gauge system, for determination of a filling level of a product contained in a tank using electromagnetic signals, said level gauge system comprising:
transmission signal generating circuitry for generating a transmission signal in the form of a sequence of transmission pulses;
a propagation device connected to said transmission signal generating circuitry and arranged to propagate said transmission signal towards a surface of said product inside the tank, and to return a reflected signal resulting from reflection of said transmission signal at said surface of the product contained in the tank;
reference signal providing circuitry configured to provide a reference signal in the form of a sequence of reference pulses,
at least one of the transmission signal generating circuitry and the reference signal providing circuitry comprising delay circuitry for providing a time-varying phase difference between the transmission signal and the reference signal;
measurement circuitry connected to said propagation device and to said reference signal providing circuitry, said measurement circuitry being configured to provide a measurement signal based on said reference signal and said reflected signal; and
processing circuitry connected to said measurement circuitry for determining a filling level based on said measurement signal,
wherein said delay circuitry comprises:
at least one supply voltage controlled delay cell exhibiting a propagation delay for pulses passing through the at least one supply voltage controlled delay cell that varies in dependence of a supply voltage provided to the at least one supply voltage controlled delay cell; and
voltage control circuitry connected to the at least one supply voltage controlled delay cell for providing a controllable supply voltage to the at least one supply voltage controlled delay cell, to thereby allow control of a signal propagation delay of the delay circuitry.

2. The level gauge system according to claim 1, wherein said delay circuitry comprises a plurality of supply voltage controlled delay cells connected in series, each supply voltage controlled delay cell exhibiting a propagation delay for pulses passing through the supply voltage controlled delay cell that varies in dependence of a supply voltage provided to the supply voltage controlled delay cell.

3. The level gauge system according to claim 2, wherein said voltage control circuitry is connected to each of said supply voltage controlled delay cells to allow simultaneous control of the supply voltage provided to each of said supply voltage controlled delay cells.

4. The level gauge system according to claim 1, wherein said delay circuitry comprises:
a plurality of delay elements; and
controllable switching circuitry arranged and configured to allow formation of a delay path through a selected number of said delay elements connected in series.

5. The level gauge system according to claim 4, wherein said switching circuitry comprises controllable switching elements arranged between adjacent ones of said delay elements.

6. The level gauge system according to claim 4, wherein at least one of the delay elements is a supply voltage controlled delay cell exhibiting a propagation delay for pulses passing through the supply voltage controlled delay cell that varies in dependence of a supply voltage provided to the supply voltage controlled delay cell.

7. The level gauge system according to claim 1, wherein said level gauge system further comprises a phase detector arranged to provide a signal indicative of a propagation delay through said delay circuitry.

8. The level gauge system according to claim 7, wherein said voltage control circuitry is connected to said phase detector and configured to provide said controllable supply voltage in dependence of said signal provided by the phase detector.

9. The level gauge system according to claim 1, wherein said at least one delay cell is a logic circuit comprising at least one transistor.

10. The level gauge system according to claim 9, wherein said logic circuit is an inverter.

11. The level gauge system according to claim 1, wherein the propagation device is a transmission line probe.

12. The level gauge system according to claim 1, wherein the propagation device comprises a radiating antenna.

13. The level gauge system according to claim 1, being powered by a local power source comprising at least one device selected from the group comprising a battery device, a solar cell, and a wind turbine.

14. The level gauge system according to claim 1, further comprising a radio transceiver for wireless communication with an external device.

15. A method of determining a filling level of a product contained in a tank using electromagnetic signals, said method comprising the steps of:
generating a transmission signal in the form of a sequence of pulses;
propagating said transmission signal towards a surface of said product contained in the tank;
receiving a reflected signal resulting from reflection of said transmission signal at said surface of said product;
providing a reference signal in the form of a sequence of pulses;
forming a measurement signal based on said reference signal and said reflected signal; and
determining said filling level based on said measurement signal,
wherein at least one of said steps of generating said transmission signal and providing said reference signal comprises the steps of:
passing said pulses through at least one supply voltage controlled delay cell exhibiting a propagation delay for said pulses that varies in dependence of a supply voltage provided to the at least one supply voltage controlled delay cell; and
varying the supply voltage to said at least one supply voltage controlled delay cell, to thereby provide a time-varying phase difference between the transmission signal and the reference signal.

101-115. (canceled)
